(19) United States
(12) Patent Application Publication
(10) Pub. No.: US 2013/0016921 A1
(43) Pub. Date: Jan. 17, 2013

(54) METHOD FOR PROVIDING LOCALIZED IMAGES FOR SOFTWARE PRODUCTS

(71) Applicants: Piotr Beltowski, Krakow (PL); Rossella De Gaetano, Rome (IT); David W. Knapp, JR., Piaseczno (PL); Wojciech Kocjan, Rybnik (PL)

(72) Inventors: Piotr Beltowski, Krakow (PL); Rossella De Gaetano, Rome (IT); David W. Knapp, JR., Piaseczno (PL); Wojciech Kocjan, Rybnik (PL)

(73) Assignee: INTERNATIONAL BUSINESS MACHINES CORPORATION, Armonk, NY (US)

(21) Appl. No.: 13/184,146

(22) Filed: Jul. 15, 2011

(51) Int. Cl. G06K 9/54

(52) U.S. Cl. 382/305

(57) ABSTRACT

A method for producing a specified image includes generating a first file segment for an imaging file, the first file segment containing graphic information that is locale independent. A plurality of locale dependent files is generated that each contains information representing locale dependent graphic content. Graphic content information of each locale dependent file is incorporated into the image file as a locale dependent file segment. The method further includes selecting the first file segment and each of the locale dependent file segments that pertain only to a particular locale. The selected file segments are then rendered into respectively corresponding image layers, the layers corresponding to a given selected file segment containing the graphic content information thereof. Each of the image layers are then combined to produce the specified image.

### BACKGROUND

1. Field of the Invention

The invention disclosed and claimed herein pertains to a method for providing localized images for software-related products, that is, images which are adapted for different locales to which the product is sent. More particularly, the invention pertains to a method of the above type for varying graphic elements of the images, including the language which is used for textual content, according to the locale to which the product is intended.

2. Description of Related Art

When a software product such as documentation is to be provided to different locations or locales, such as to different countries or different regions in the same country, it may be necessary to translate textual content in the product into different languages for the respective locales. This task can be quite burdensome, especially if the text is combined with an image. As an example, in order to furnish software documentation to a locale that requires a particular language, images included in the documentation which contain text must be localized or translated to that language. However, providing images in different languages typically implies running the product in different languages, and then taking screenshots for each language. Moreover, a different copy of the image must be packaged and distributed to each different locale. If the product then changes, the screenshot needs to be retaken. This process limits the number of changes that can be made after the translation, and is both time consuming and expensive.

### SUMMARY OF THE INVENTION

Embodiments of the invention can be used to provide documentation and other software products that include both an image and text which can be readily selected from one of a number of different languages. In these embodiments the language translators only need to deal with text files, and do not need to see the product when it is running. Further benefits and advantages of the invention are described hereinafter. One embodiment is directed to a method for producing a specified image, which includes the step of generating a first file segment for an imaging file, wherein the first file segment contains information representing graphic content of the specified image that is locale independent, or not dependent on locale. The method further comprises generating a plurality of locale dependent files, wherein each locale dependent file contains information representing graphic content that is locale dependent, and at least two of the locale dependent files pertain to locales that are different from each other. Graphic content information of each locale dependent file is incorporated into the image file, as a locale dependent file segment of the image file. The method further comprises selecting the first file segment, and further selecting each of the locale dependent file segments that pertain only to a particular one of the locales. Each of the selected file segments are then rendered into a respectively corresponding image layer, wherein the image layer corresponding to a given selected file segment contains the graphic content information of the given selected file segment. Each of these image layers are then selectively combined, in order to produce the specified image.

As used in this application, the term “locale” means or refers to a geographical area in which embodiments of the invention are intended for use, such as a nation or country, or specified region thereof.

As used in this application, the term “locale independent”, when applied to a thing or entity, means or refers to a thing or entity which is not regarded differently by intended users who reside in different locales, and can be used by most intended users in each locale.

As used in this application, the term “locale dependent”, when applied to a thing or entity, means or refers to a thing or entity which is regarded differently by intended users in different locales, and/or can be used only in one locale by many or most of the users in that locale.

### BRIEF DESCRIPTION OF THE DRAWINGS

FIG. 1 is a schematic diagram that illustrates combining image layers to produce a complete localized image, in accordance with an embodiment of the invention.

FIG. 2 is a flowchart depicting initial steps for a method comprising an embodiment of the invention.

FIG. 3 is a flowchart depicting additional steps for the method of FIG. 2.

FIG. 4 is a block diagram showing a data processing system which may be used in implementing embodiments of the invention.

### DETAILED DESCRIPTION OF THE PREFERRED EMBODIMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

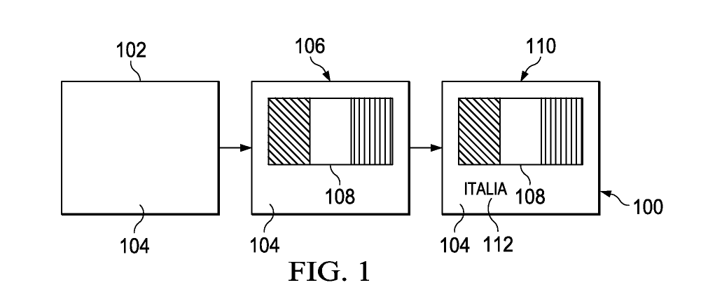

As described above, documentation and other software products can include both images and textual content. FIG. 1 shows a simplified image that includes both textual and non-textual graphic content, for purposes of illustration. If a product is to be distributed to locales that use different languages from one another, the textual content must be translated into each of these languages. In the past, language translators typically needed to see the product running, and also needed to take screen shots of proper operation. The developers also needed to build development images for the translators.

In accordance with the invention, it has been recognized that a complete image of the above type can comprise multiple image components or elements, wherein one component will be the same, regardless of the location or locale in which it is used and regardless of users. One or more other image components, however, such as the language in which text appears, will be very dependent on the locale of use. In view of this, it has been recognized further that the content of different image components can be placed on different image layers. Different layers can then be combined, as described hereinafter in further detail, to produce a complete or composite image for a particular locale.

It is anticipated that embodiments of the invention will enable language translators to deal only with text files. They will not need to see the product running, or to edit the image as a binary file. Also, the software package in which the product is shipped may comprise only a single image file, which can be used in all locales. Multiple image files, one for each different language, will therefore not be required.

Referring to FIG. 1, there is shown a complete image 100 of the above type. Complete mage 100 is formed by combining image layers 102, 106, and 110. Image layer 102 depicts a star or light pattern 104. Clearly, this graphic content is locale independent, since light pattern 104 will have the same effect on all users, or appear the same to all users, regardless of user locale.

Referring further to FIG. 1, there is shown image layer 106 overlaying layer 102. A portion of image layer 106 has transparent capability, so that a portion of light pattern 104 remains viewable. Image layer 106 includes image element 108 that depicts the flag of Italy. This element clearly has a different significance to users in the locale of Italy than to users in other countries. Thus, the graphic content of image layer 106 is locale dependent.

FIG. 1 further shows image layer 110 configured to overlay both image layers 102 and 106. The portion of image layer 110 likewise has a transparent capability, so that both a portion of light pattern 104 and image element 108 remain viewable. Image layer 110 includes image element 112, which comprises textual content in the Italian language, and more particularly comprises the word “Italy” in such language. Image element 112 is clearly locale dependent, if other locales include countries or regions which use languages other than Italian.

FIG. 1 thus discloses that a complete image 100, which has both locale independent and locale dependent elements, can be readily generated by overlaying image layers as described above.

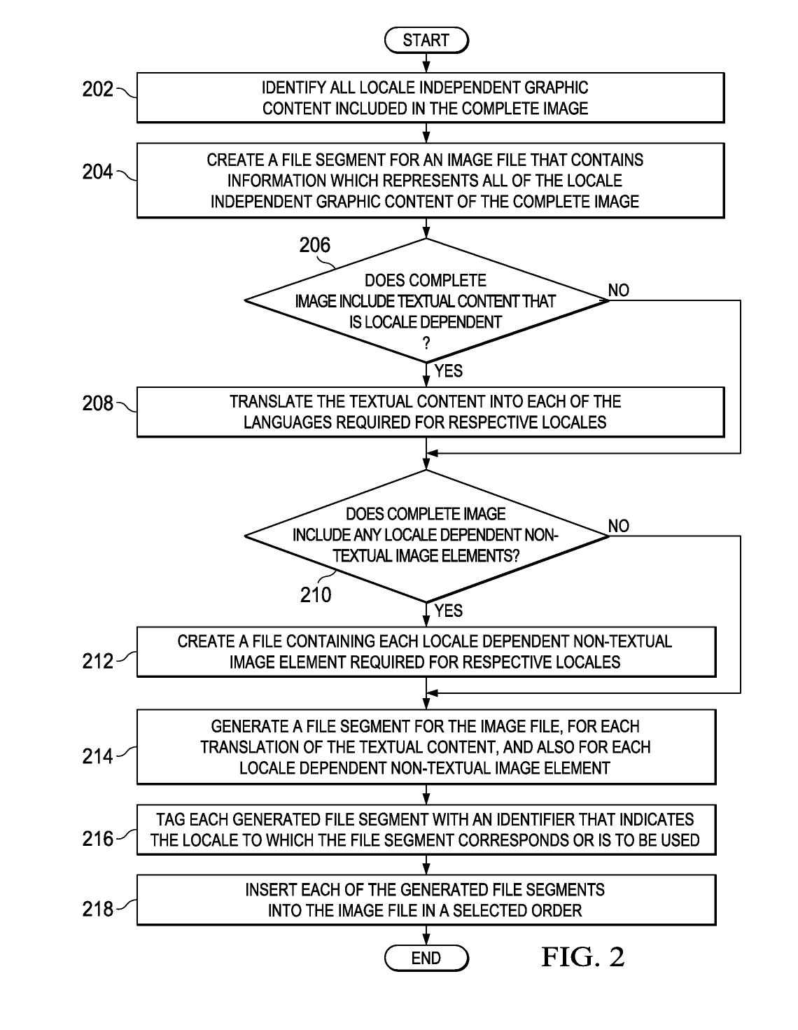

Referring to FIG. 2, there is shown a flowchart that includes steps for a method comprising an embodiment of the invention. The method is directed to building or generating a complete image, such as complete image 100 of FIG. 1, which contains both locale independent and locale dependent elements. At initial step 202, all the locale independent graphic content included in the complete image is identified or determined. For complete image 100 of FIG. 1, light pattern 104 would be identified as the locale independent graphic content.

At step 204 of the method of FIG. 2, it is necessary to create a file segment for an image file, wherein the file segment contains information representing all of the locale independent graphic content of the complete image identified at step 202. For the example of complete image 100, the file segment would contain information representing light pattern 104 of FIG. 1.

In one useful embodiment of the invention, the image file could use Graphics Interchange Format (GIF), which is a bitmap image format. A GIF file describes a fixed size graphical area, or logical screen, which can contain one or more images and may be divided into separate sub-images. Also, the GIF file can be divided into file segments, wherein each segment is introduced by a sentinel byte and includes an image, or frame. Each image or frame has an associated color or palette table and may be provided with a transparency capability. This is achieved by assigning a pixel with a transparent background color index, whereupon the pixel is given the same color as a pixel which is at the same position in a previous or background image or frame.

If GIF is used for the image file format at step 204, the locale independent graphic content of the complete image is incorporated into a file segment that is the first segment, or base segment, of the GIF file. It is to be understood that embodiments of the invention are not limited to GIF and could alternatively use image file formats such as Portable Network Graphics (PNG), BMP, or other image formats that are known to and used by those of skill in the art.

Referring further to FIG. 2, step 206 determines whether or not the complete image includes textual content that is locale dependent. If this query is affirmative, the method of FIG. 2 proceeds to step 208. Otherwise, the method bypasses step 208 and goes directly to step 210. In the example of FIG. 1, the complete image 100 includes text in the Italian language. If complete image 100 is to be used in a product intended for distribution to locales that use languages other than Italian, the textual content of complete image 100 is clearly locale dependent, and the method goes to step 208.

Step 208 initially requires determining or recognizing each language that will be needed, for each locale to which the complete image will be sent. The textual content of the complete image is then made available to language translators, who respectively proceed to translate the textual content into each of the necessary languages. However, the role of translators in the method of FIG. 2 is much more limited than their role in certain prior art techniques.

For example, as described above, the translators do not need to see the product associated with the complete image in a running mode, and they do not need to edit the image as a binary file. To the contrary, the principal task of a translator is to translate the textual content into a particular language, and to provide the translated content in a text file, such as an XML file. Thus, embodiments of the invention provide significant isolation between the work of the product developers and the work of language translators. The translators work only with text files and translation information contained in the text files can be automatically merged into the image file, as described hereinafter in further detail.

Step 210 of the method of FIG. 2 determines whether or not the complete image includes any locale dependent non-textual image elements. If this query is affirmative, the method proceeds to step 212. Otherwise the method bypasses step 212 and goes directly to step 214. As described above, complete image 100 of FIG. 1 includes an image of the flag of Italy, and therefore does include a locale dependent non-textual element.

Step 212 requires creating or furnishing a file that contains each non-textual image element that is needed to adapt the complete image for use in each of the intended locales. For example, if the product of complete image 100 was to be sent to a number of different countries, the file would include information for producing an image of the flag of each of those countries. It is anticipated that a file for step 212 could be created by developers of the software product associated with the complete image.

At step 214, a file segment is generated for the image file described in connection with step 204, for each translation of textual content that is carried out for each locale in accordance with step 208. A further file segment is generated for the image file, for each non-textual image element which is furnished in accordance with step 212.

As described above in connection with FIG. 1, the complete image 100 is formed or constructed by overlaying image layers, wherein some of the image layers include both graphic content and a transparent portion. As described hereinafter in further detail, embodiments of the invention make use of file segments generated at step 214 to render image layers of the type described in FIG. 1. Accordingly, it is advantageous to use a format such as GIF for the image file. GIF can produce an image layer that contains graphic content, and also has a portion that is transparent or appears to be transparent to viewer.

At step 216, each file segment generated at step 214 is tagged with an identifier that indicates the locale to which the file segment corresponds or is to be used. For example, a numerical or other code could be placed in the header of each file segment, wherein the code identifies a particular country, region or other locale to which the segment corresponds.

At step 218 of FIG. 2, the file segments generated at step 214 are inserted into the image file in a selected order. For example, each of these file segments could be placed in the image file following the locale independent file segment created at step 204, in a sequence determined by their respective numerical or other locale identifiers.

In a useful embodiment of the invention, respective steps of the method of FIG. 2 could be carried out by a tool configured to build a GIF or other image file. Following step 218, the image file may be packaged with a software product to which it applies, and distributed to users in each of the intended locales.

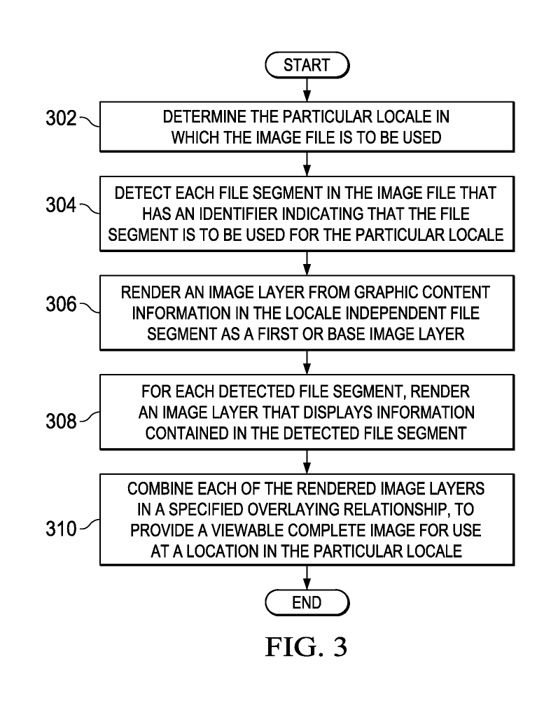

When the package is received by a user in a particular locale, the user may execute or run a program to access the image file, in order to produce a complete image of the type described above. In one embodiment, the package contains a software image rendering tool which may be used for this purpose. When the tool is operated, it carries out a process comprising a series of steps with respect to the image file, as shown by FIG. 3.

Referring to FIG. 3, upon starting the image rendering tool, the particular locale in which the image file is to be used is determined at step 302. This information could be provided by user input, or can be automatically detected by looking at the configuration of the system where the application runs. At step 304, the tool searches the identifiers of respective locale dependent file segments, to detect each file segment having an identifier which corresponds to the particular locale. There may be one or more of these file segments for the particular locale.

Referring further to FIG. 3, at step 306 an image layer is produced or rendered from graphic content information in the locale independent file segment. This image layer comprises a base image layer for an intended complete image, and will be used at each of the locales. At step 308, an image layer is rendered from each file segment detected for the particular locale, wherein the image layer displays information contained in such file segment. One such image layer could show textual content in the language of the particular locale. Another such layer could depict a symbol that was unique or of special significance to the particular locale.

At step 310, each of the image layers described above are combined in a specified overlaying relationship, to provide a viewable image that is complete in that it displays graphic content of each of the image layers. Typically, the lowest or base layer would be the locale independent layer. Each of the locale dependent image layers would be placed upon the base layer, in an order that was prespecified if there was more than a single locale dependent image layer for the particular locale.

In a further embodiment, the specified image could be displayed by using a web browser to read the image layer of the locale independent file segment, and also to read each image layer of each locale dependent file segment that pertained to a particular locale of interest.

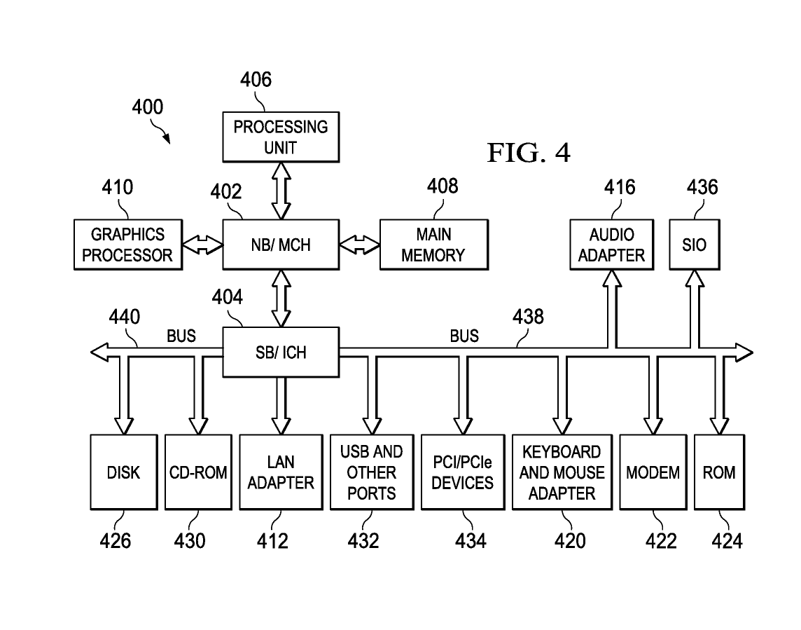

Referring to FIG. 4, a block diagram of a computer or data processing system is shown in which aspects of the present invention may be implemented. This system is an example of a computer which may be used to operate a tool for carrying out respective steps of either FIG. 2 or FIG. 3, and in which computer usable code or instructions implementing the processes for embodiments of the present invention may be located.

In the depicted example, the data processing system of FIG. 4 employs a hub architecture including north bridge and memory controller hub (NB/MCH) 402 and south bridge and input/output (I/O) controller hub (SB/ICH) 404. Processing unit 406, main memory 408, and graphics processor 410 are connected to NB/MCH 402. Graphics processor 410 may be connected to NB/MCH 402 through an accelerated graphics port (AGP).

In the depicted example, local area network (LAN) adapter 412 connects to SB/ICH 404. Audio adapter 416, keyboard and mouse adapter 420, modem 422, read only memory (ROM) 424, disk 426, CD-ROM 430, universal serial bus (USB) ports and other communication ports 432, and PCI/PCIe devices 434 connect to SB/ICH 404 through bus 438 and bus 440. PCI/PCIe devices 434 may include, for example, Ethernet adapters, add-in cards, and PC cards for notebook computers. PCI uses a card bus controller, while PCIe does not. ROM 424 may be, for example, a flash binary input/output system (BIOS).

Disk 426 and CD-ROM 430 connect to SB/ICH 404 through bus 440. Disk 426 and CD-ROM 430 may use, for example, an integrated drive electronics (IDE) or serial advanced technology attachment (SATA) interface. Super I/O (SIO) device 436 may be connected to SB/ICH 404.

An operating system runs on processing unit 406 and coordinates and provides control of various components within the data processing system of FIG. 4. As a client, the operating system may be a commercially available operating system such as Microsoft® Windows® (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on the data processing system (Java is a trademark of Sun Microsystems, Inc. in the United States, other countries, or both).

As a server, the data processing system of FIG. 4 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). The data processing system may be a symmetric multiprocessor (SMP) system including a plurality of processors in processing unit 406. Alternatively, a single processor system may be employed.

Instructions for the operating system, the object-oriented programming system, and applications or programs are located on storage devices, such as disk 426, and may be loaded into main memory 408 for execution by processing unit 406. The processes for embodiments of the present invention are performed by processing unit 406 using computer usable program code, which may be located in a memory such as, for example, main memory 408, ROM 424, or in one or more peripheral devices, such as, for example, disk 426 and CD-ROM 430.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for producing a specified image, comprising the steps of:
generating a first file segment for an image file, wherein the first file segment contains information representing graphic content of the specified image that is not dependent on locale;
generating a plurality of locale dependent files, wherein each locale dependent file contains information representing graphic content that is locale dependent, and at least two of the locale dependent files pertain to locales that are different from one another;
incorporating the graphic content information of each locale dependent file into the image file, as a locale dependent file segment of the image file;
selecting said first file segment, and further selecting each of the locale dependent file segments that pertain only to a particular one of the locales;
rendering each of the selected file segments into a respectively corresponding image layer, wherein the image layer corresponding to a given selected file segment contains the graphic content information of the given selected file segment; and
selectively combining each of the image layers to produce said specified image.

2. The method of claim 1, wherein:
an identifier is provided for each locale dependent file segment of the image file, wherein the identifier provided for a locale dependent file segment identifies the locale to which that locale dependent file segment pertains.

3. The method of claim 1, wherein:
the graphic content information of one of the locale dependent file segments comprises textual content in a particular language, and the graphic content information of another one of the locale dependent file segments comprises the same textual content in a language that is different from the particular language.

4. The method of claim 1, wherein:
the graphic content information of one of the locale dependent file segments comprises textual content in a particular language, and the graphic content information of another one of the locale dependent file segments represents a non-textual element for said specified image.

5. The method of claim 1, wherein:
said step of combining each of the image layers comprises selecting the image layer rendered from the first file segment to be a base image layer, and overlaying the base image layer with each of the image layers rendered from respective selected locale dependent file segments, wherein the overlaying layers are placed upon the base image layer in a prespecified order.

6. The method of claim 5, wherein:
said overlaying image layers are respectively configured to provide said specified image in a viewable form, wherein said viewable form includes graphic content that is contained in the base image layer, and also in each of the overlaying image layers.

7. The method of claim 1, wherein:
a first software tool is provided, to create said image file including said first file segment and each of said locale dependent file segments.

8. The method of claim 1, wherein:
a second software tool is provided, in order to selectively process said image file to generate said specified image.

9. The method of claim 1, wherein:
said specified image is displayed by using a browser to read the image layer of the first file segment, and also to read each image layer of each locale dependent file segment that pertains to the particular locale.

10. The method of claim 1, wherein:
the image file has a format selected from a group that includes at least Graphic Interchange Format, Portable Network Graphics, and BMP.

11. A computer program product executable in a computer recordable storage medium for generating a specified image, said computer program product comprising:
instructions for generating a first file segment for an image file, wherein the first file segment contains information representing graphic content of the specified image that is not dependent on locale;
instructions for generating a plurality of locale dependent files, wherein each locale dependent file contains information representing graphic content that is locale dependent, and at least two of the locale dependent files pertain to locales that are different from one another;
instructions for incorporating the graphic content information of each locale dependent file into the image file, as a locale dependent file segment of the image file;
instructions for selecting the first file segment, and for further selecting each of the locale dependent file segments that pertain only to a particular one of the locales;
instructions for rendering each of the selected file segments into respectively corresponding image layers, wherein the image layer corresponding to a given selected file segment contains the graphic content information of the given selected file segment; and
instructions for selectively combining each of the image layers to produce said specified image.

12. The computer program product of claim 11, wherein:
an identifier is provided for each locale dependent file segment of the image file, wherein the identifier provided for a locale dependent file segment identifies the locale to which that locale dependent file segment pertains.

13. The computer program product of claim 11, wherein:
the graphic content information of one of the locale dependent file segments comprises textual content in a particular language, and the graphic content information of another one of the locale dependent file segments comprises the same textual content in a language that is different from the particular language.

14. The computer program product of claim 11, wherein:
the graphic content information of one of the locale dependent file segments comprises textual content in a particular language, and the graphic content information of another one of the locale dependent file segments represents a non-textual element for said specified image.

15. The computer program product of claim 11, wherein:
combining each of the image layers comprises selecting the image layer rendered from the first file segment to be a base image layer, and overlaying the base image layer with each of the image layers rendered from respective selected locale dependent file segments, wherein the overlaying layers are placed upon the base image layer in a prespecified order.

16. Apparatus for generating a specified image, comprising:
processing means for generating a first file segment for an image file, wherein the first file segment contains information representing graphic content of the specified image that is not dependent on locale;
processing means for generating a plurality of locale dependent files, wherein each locale dependent file contains information representing graphic content that is locale dependent, and at least two of the locale dependent files pertain to locales that are different from one another;
processing means for incorporating the graphic content information of each locale dependent file into the image file, as a locale dependent file segment of the image file;
processing means for selecting the first file segment, and for further selecting each of the locale dependent file segments that pertain only to a particular one of the locales;
processing means for rendering each of the selected file segments into respective corresponding image layers, wherein the image layer corresponding to a given selected file segment contains the graphic content information of the given selected file segment; and
processing means for selectively combining each of the image layers to produce said specified image.

17. The apparatus of claim 16, wherein:
an identifier is provided for each locale dependent file segment of the image file, wherein the identifier provided for a locale dependent file segment identifies the locale to which that locale dependent file segment pertains.

18. The apparatus of claim 16, wherein:
the graphic content information of one of the locale dependent file segments comprises textual content in a particular language, and the graphic content information of another one of the locale dependent file segments comprises the same textual content in a language that is different from the particular language.

19. The apparatus of claim 16, wherein:
the graphic content information of one of the locale dependent file segments comprises textual content in a particular language, and the graphic information of another one of the locale dependent file segments represents a non-textual element for said specified image.

20. The apparatus of claim 16, wherein:
a first software tool is provided, to create said image file including said first file segment and each of said locale dependent file segments, and a second software tool is provided, in order to selectively process said image file to generate said specified image.
